(19) United States
(12) Patent Application Publication
(10) Pub. No.: US 2013/0162562 A1
(43) Pub. Date: Jun. 27, 2013

(54) INFORMATION PROCESSING DEVICE AND NON-TRANSITORY RECORDING MEDIUM STORING PROGRAM

(71) Applicant: BUFFALO INC., Nagoya-shi (JP)

(72) Inventors: Aya FUJIKI, Nagoya-shi (JP); Yoshiki OSAWA, Nagoya-shi (JP)

(73) Assignee: BUFFALO INC., Nagoya-shi (JP)

(21) Appl. No.: 13/710,521

(22) Filed: Dec. 11, 2012

(30) Foreign Application Priority Data
Dec. 22, 2011 (JP) 2011-281920

(51) Int. Cl. G06F 3/041

(52) U.S. Cl. CPC G06F 3/041
USPC 345/173

(57) ABSTRACT

An information processing device includes a display section, and a touch sensor superposed on the display section, the touch sensor being responsive to touch operation by a user. An estimation unit is also provided and is configured to identify a region on the display section, the region being covered by a part of the user, when the touch sensor detects the touch operation by the user. A display controller is provided that displays information on the display section so as to avoid the region identified by the estimation unit. In addition a computer program product is described.

### CROSS REFERENCE TO RELATED APPLICATION

The present application claims priority to Japanese Patent Application No. 2011-281920 filed on Dec. 22, 2011, the disclosure of which is hereby incorporated by reference in its entirety.

### FIELD OF THE INVENTION

The present disclosure relates to an information processing device including a smart phone, a tablet PC, and the like, and a non-transitory recording medium storing a program executed in the information processing device.

### RELATED ARTS

Information processing devices such as smart phones, tablet PCs, and the like, which have a touch panel and are operated with a fingertip, have recently spread widely. Such an information processing device is operated with a fingertip of a user, and thus has operation characteristics different from those of input devices such as a mouse, a keyboard, and the like.

For example, Japanese Patent Laid-Open No. 2003-271294 discloses techniques that recognize the limitation of the reach of a finger as a problem in a case where a terminal having a large screen is operated while held with both hands, and which techniques display information in such a manner as to avoid a range that a thumb does not reach easily.

In addition, in an information processing device using a touch panel, regardless of the size of the screen, a part of the screen is covered by a hand of a user when a touch operation (an operation of touching or an operation of continuing touching) is performed on an image of an icon or the like to be operated. Therefore, when information is displayed in such a covered range, the user needs to take off the hand temporarily or change the orientation of the hand unnaturally to view the information, thus resulting in a low level of convenience.

The present disclosure has been made in view of the above actual situation, and it is an object of the present disclosure to provide an information processing device and a program that can maintain convenience even when such an operation as to cover a part of the screen with a hand is performed.

### SUMMARY

According to one aspect of the present disclosure, there is provided an information processing device that includes a display section, and a touch sensor superposed on the display section, the touch sensor being responsive to touch operation by a user. An estimation unit is also provided and is configured to identify a region on the display section, the region being covered by a part of the user, when the touch sensor detects the touch operation by the user. A display controller is provided that displays information on the display section so as to avoid the region identified by the estimation unit.

According to another aspect, an information processing device includes a display section; a touch sensor superposed on the display section, the touch sensor being responsive to a touch operation by a user; means for estimating a region on the display section, the region being covered by a part of a body of the user, when the touch sensor detects the touch operation by the user; and display means for displaying information on the display section in such a manner as to avoid the estimated region.

According to another aspect of the present disclosure, there is provided a non-transitory recording medium having instructions stored therein that when executed by a computer cause the computer to implement an information processing device that is connected to a display section and a touch sensor superposed on the display section, the touch sensor being responsive to touch operation by a user, the information processing device including

an estimation unit configured to identify a region on the display section, the region being covered by a part of the user, when the touch sensor detects the touch operation by the user; and

a display controller that displays information on the display section so as to avoid the region identified by the estimation unit.

### BRIEF DESCRIPTION OF DRAWINGS

FIG. 1 is a block diagram showing an example of configuration of an information processing device according to one aspect of an embodiment of the present disclosure;

FIG. 2 is a diagram of assistance in explaining an example of a coordinate system that can be adopted virtually in the information processing device according to one aspect of the embodiment of the present disclosure;

FIG. 3 is a functional block diagram showing an example of the information processing device according to one aspect of the embodiment of the present disclosure;

FIG. 4 is a flowchart of an example of a process for determining a position in which to avoid display in the information processing device according to one aspect of the embodiment of the present disclosure;

FIG. 5A is a diagram of assistance in explaining an example of a manner of holding the information processing device according to one aspect of the embodiment of the present disclosure;

FIG. 5B is a diagram of assistance in explaining an example of a manner of holding the information processing device according to one aspect of the embodiment of the present disclosure;

FIG. 5C is a diagram of assistance in explaining an example of a manner of holding the information processing device according to one aspect of the embodiment of the present disclosure;

FIG. 5D is a diagram of assistance in explaining an example of a manner of holding the information processing device according to one aspect of the embodiment of the present disclosure;

FIG. 6A is a diagram of assistance in explaining an example of an information display position in the information processing device according to one aspect of the embodiment of the present disclosure;

FIG. 6B is a diagram of assistance in explaining an example of an information display position in the information processing device according to one aspect of the embodiment of the present disclosure;

FIG. 6C is a diagram of assistance in explaining an example of an information display position in the information processing device according to one aspect of the embodiment of the present disclosure;

FIG. 6D is a diagram of assistance in explaining an example of an information display position in the information processing device according to one aspect of the embodiment of the present disclosure;

FIG. 7A is a diagram of assistance in explaining an example of operation of the information processing device according to one aspect of the embodiment of the present disclosure;

FIG. 7B is a diagram of assistance in explaining an example of operation of the information processing device according to one aspect of the embodiment of the present disclosure;

FIG. 7C is a diagram of assistance in explaining an example of operation of the information processing device according to one aspect of the embodiment of the present disclosure; and

FIG. 7D is a diagram of assistance in explaining an example of operation of the information processing device according to one aspect of the embodiment of the present disclosure.

### DESCRIPTION OF THE DISCLOSURE

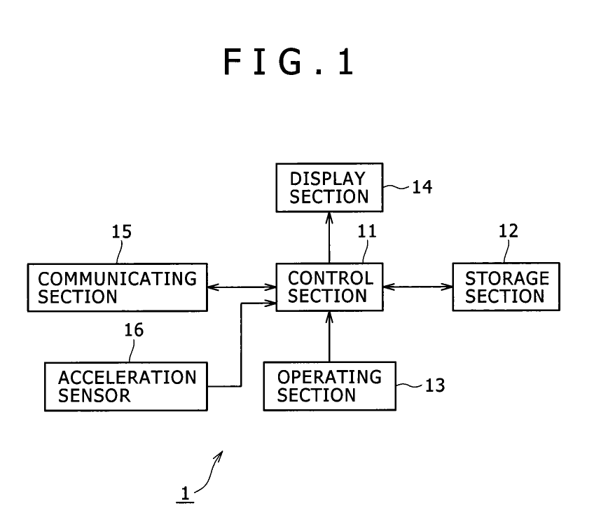

A preferred embodiment of the present disclosure will be described with reference to the drawings. As illustrated in FIG. 1, an information processing device 1 according to one aspect of the embodiment of the present disclosure includes a control section 11, a storage section 12, an operating section 13, a display section 14, a communicating section 15, and an acceleration sensor 16. The operating section 13 is an operating device that receives an operation from a user, at which time the display section 14 as a display device may be covered by a part of the body of the user such as a hand, an arm or the like of the user. Specifically, the operating section 13 is for example a touch panel having a transparent touch sensor disposed so as to be superposed on the display section 14. The operating section 13 outputs information on the operation received from the user (information on a position at which the touch operation is performed or the like) to the control section 11.

The control section 11 is a program control device such as a CPU (Central Processing Unit) or the like. The control section 11 operates according to a program stored in the storage section 12. In the present embodiment, when the operating section 13 detects a touch operation by the user, the control section 11 estimates a region on the display section 14 which region is covered by a part of the body of the user. Then, the control section 11 performs a process of displaying information on the display section 14 in such a manner as to avoid the estimated region. Details of the process by the control section 11 will be described later.

The storage section 12 is a memory device or the like. The storage section 12 retains the program executed by the control section 11. The program may be provided in a state of being stored on a computer-readable non-transitory recording medium such for example as a DVD-ROM (Digital Versatile Disc Read Only Memory), and then stored in the storage section 12. In addition, the program may be distributed via communicating means such as the Internet or the like, and then stored in the storage section 12. The storage section 12 also operates as a work memory for the control section 11.

The display section 14 is a display device such as a liquid crystal display or the like having a rectangular display surface or screen, for example. The display section 14 displays an image on the display surface according to an instruction input from the control section 11. The communicating section 15 is for example a wireless LAN (Local Area Network) communicating device. The communicating section 15 outputs information received via communicating means such as a network or the like to the control section 11. In addition, the communicating section 15 sends out designated information via the communicating system such as the network or the like according to an instruction input from the control section 11. Incidentally, the communicating section 15 may include a portable telephone communicating device that performs data communication and voice communication via a portable telephone line.

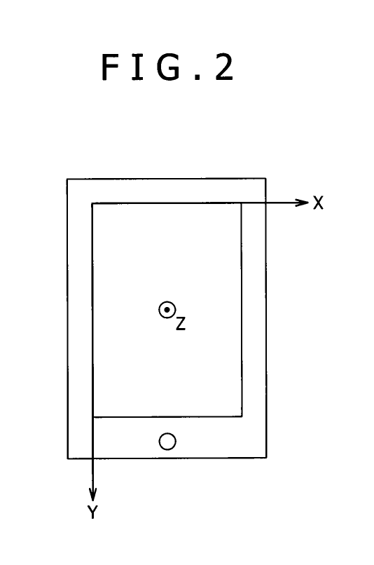

The acceleration sensor 16 is a device for detecting acceleration in the directions of three axes orthogonal to each other, that is, an X-axis, a Y-axis, and a Z-axis. The acceleration sensor 16 may be a widely known acceleration sensor of a piezoresistive type, a capacitance type, or the like. Incidentally, the X-axis, the Y-axis, and the Z-axis may be disposed in any directions in the information processing device 1. However, as an example, as shown in FIG. 2, an axis along a short side of the display section 14 in a substantially rectangular shape is set as the X-axis, the direction of length of the display section 14 is set as the Y-axis, and the direction of a normal to the display section 14 is set as the Z-axis. The acceleration sensor 16 detects respective accelerations in the X-direction, the Y-direction, and the Z-direction which accelerations are applied to the acceleration sensor 16 itself (acceleration occurring when the information processing device 1 itself is moved, the acceleration of gravity, and the like), and outputs information indicating the accelerations in the respective directions (voltage signals proportional to the magnitudes of the accelerations or the like).

The operation of the control section 11 will next be described. In an example of the present embodiment, the control section 11 performs the processing of an API (Application Program Interface) shared by application programs operating on the information processing device 1. The control section 11 in the present embodiment performs API processing for displaying a message. This API processing performs a process of displaying a graphic image (frame) in a rectangular shape and displaying a text as the message within the frame.

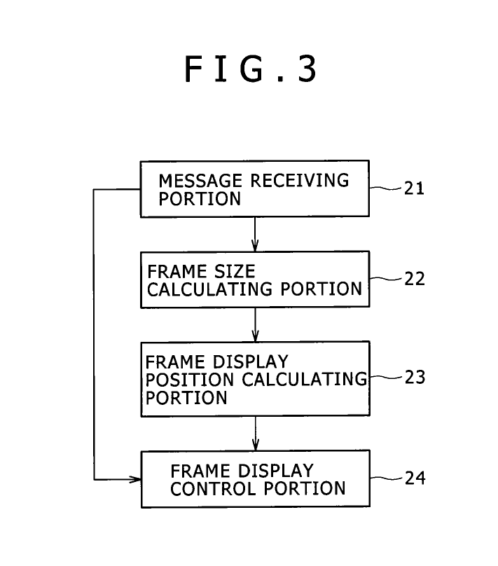

As illustrated in FIG. 3, the control section 11 performing this processing functionally includes a message receiving portion 21, a frame size calculating portion 22, a frame display position calculating portion (means for estimating a region on the display device which region is covered by a part of the body of the user) 23, and a frame display control portion (display means) 24.

The message receiving portion 21 receives the text of a message as an object for display from an application program, and outputs the text to the frame size calculating portion 22 and the frame display control portion 24. The frame size calculating portion 22 calculates a frame size that is sufficient to enclose the text received by the message receiving portion 21. As an example, when the input text is to be arranged and displayed in a row direction in units of rows of a predetermined number of characters in a predetermined font, the frame size calculating portion 22 calculates the size (width w×height h) of a circumscribed rectangle enclosing the arranged text. The frame size calculating portion 22 then calculates the frame size as Width W=w+2×Δw and Height H=h+2×Δh by adding each of predetermined offset values (Δw in a direction of width and Δh in a direction of height) to the size of the circumscribed rectangle. The offset values are doubled in this case to provide a space of Δw to the left side of the arranged text and a space of Δw to the right side of the arranged text in the direction of width, and to similarly provide a space of Δh to the upper side of the arranged text and a space of Δh to the lower side of the arranged text in the direction of height.

The frame display position calculating portion 23 determines a position on the screen at which position to display the frame of the size calculated by the frame size calculating portion 22. Specifically, the frame display position calculating portion 23 determines a region in which the frame is not to be displayed on the basis of a position on the screen which position is touched by a finger of the user (touch position) and the orientation of the information processing device 1 which orientation is determined according to the output signal of the acceleration sensor 16, and determines the display position in such a manner as to avoid the region.

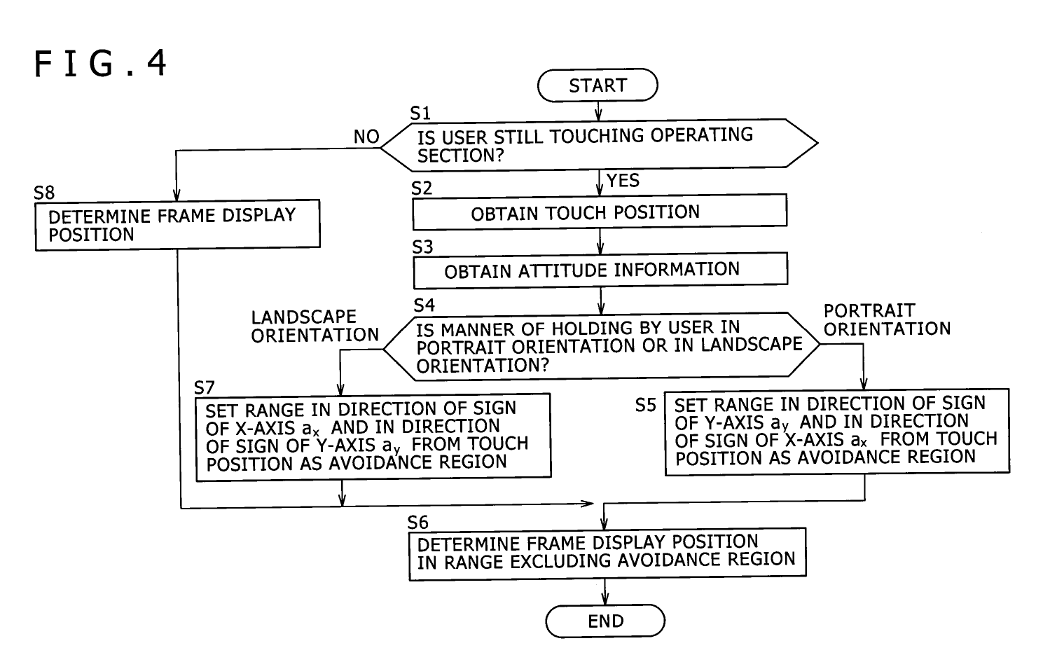

In an example of the present embodiment, the frame display position calculating portion 23 operates as illustrated in FIG. 4. The frame display position calculating portion 23 first checks whether a finger of a user is touching the touch sensor of the operating section 13 (S1). When a finger of a user is touching the touch sensor (when a result of the determination in S1 is Yes), the frame display position calculating portion 23 obtains information indicating a position touched by the finger of the user (touch position) (S2).

This information is obtained as coordinate values of an X-Y coordinate system of a pixel on the display section 14 which pixel corresponds to the touched position. As an example, as shown in FIG. 2, the X-axis is taken in the direction of a short side of the display section 14, and the Y-axis is taken in the direction of length of the display section 14. Suppose that one of predetermined vertices of the display section 14 being set as an origin O, the coordinate values of the pixel at a point separated from the origin O by x₀ pixels in the direction of the X-axis and separated from the origin O by y₀ pixels in the direction of the Y-axis are represented as (x₀, y₀).

The frame display position calculating portion 23 obtains the coordinate values (x₀, y₀) of the pixel of the display section 14 which pixel corresponds to the position touched by the finger of the user as information on the touch position in step S2. The frame display position calculating portion 23 then obtains attitude information indicating a direction from which the information processing device 1 is viewed by the user (S3). In the present embodiment, the attitude information is obtained from the output of the acceleration sensor 16. Suppose that the acceleration sensor 16 outputs the values (aₓ, a_{y}, a_{z}) of accelerations in the respective directions of the X-axis, the Y-axis, and the Z-axis. Incidentally, the attitude information may be obtained from the output of not only the acceleration sensor but also another kind of sensor as long as the sensor can detect the direction of the acceleration of gravity. When another kind of sensor is used, the acceleration sensor 16 is not necessarily required.

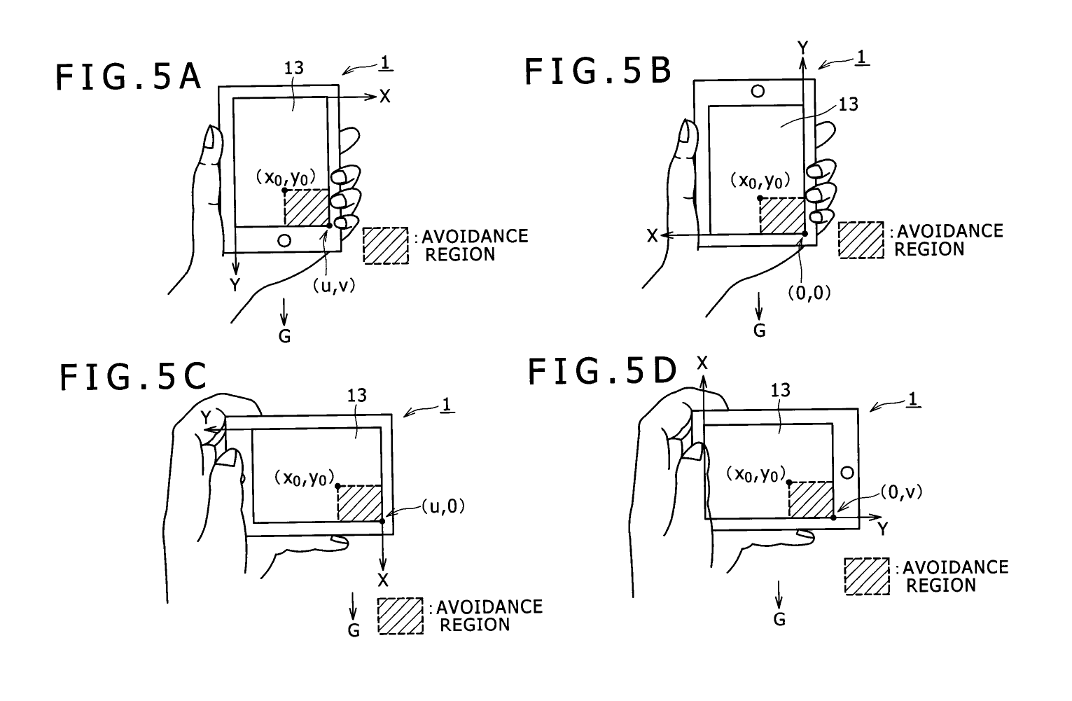

When the user holds the information processing device 1 such that the direction of length of the display section 14 is a vertical direction, as illustrated in FIGS. 5A and 5B, that is, in a case of longitudinal holding (portrait mode), the acceleration of gravity mainly affects the output of the Y-axis direction of the acceleration sensor 16, and therefore |aₓ|<|a_{y}| (where |*| means the calculation of the absolute value of *, which is also true for the following). When the user holds the information processing device 1 such that the direction of length of the display section 14 is a horizontal direction, as illustrated in FIGS. 5C and 5D, that is, in a case of lateral holding (landscape mode), the acceleration of gravity mainly affects the output of the X-axis direction of the acceleration sensor 16, and therefore |a_{y}|<|aₓ|.

The frame display position calculating portion 23 accordingly determines whether the user is holding the information processing device 1 longitudinally or laterally by comparing |aₓ| and |a_{y}| with each other (S4). When the frame display position calculating portion 23 determines that the user is holding the information processing device 1 longitudinally, as illustrated in FIG. 5A or 5B, the frame display position calculating portion 23 sets a range in the direction of the acceleration of gravity (in the direction of the sign of a_{y} on the Y-axis) from the touch position (x₀, y₀) obtained in step S2 and on a right side of the touch position (x₀, y₀) with respect to the direction of the acceleration of gravity (in the direction of the sign of aₓ on the X-axis) in the display section 14 as an avoidance region (S5).

As illustrated in FIG. 5A, for example, when the user is holding the information processing device 1 such that the direction G of the acceleration of gravity coincides with the positive direction of the Y-axis (when a_{y}>0), supposing that the size of the display section 14 is a width U and a height V (that the lower right coordinates of the display section 14 in FIG. 5A are (u, v)), the frame display position calculating portion 23 sets a rectangular region whose upper left coordinates represent the touch position (x₀, y₀) and whose lower right coordinates are (u, v) as an avoidance region.

As illustrated in FIG. 5B, for example, when the user is holding the information processing device 1 such that the direction G of the acceleration of gravity is opposite from the positive direction of the Y-axis (when a_{y}<0), the frame display position calculating portion 23 sets a rectangular region whose upper left coordinates represent the touch position (x₀, y₀) and whose lower right coordinates represent the origin (0, 0) of the display section 14 as an avoidance region.

The frame display position calculating portion 23 determines a position at which to display the frame of the size calculated by the frame size calculating portion 22 in the range other than the set avoidance region (S6), outputs information on the determined position, and then ends the process. There are various methods for the determination in step S6, which various methods will be described later.

When the frame display position calculating portion 23 determines in step S4 that the user is holding the information processing device 1 laterally, as illustrated in FIG. 5C or 5D, the frame display position calculating portion 23 sets a range in the direction of the acceleration of gravity (in the direction of the sign of aₓ on the X-axis) from the touch position (x₀, y₀) obtained in step S2 and on the right side of the touch position (x₀, y₀) with respect to the direction of the acceleration of gravity (in the direction of the sign of a_{y} on the Y-axis) in the display section 14 as an avoidance region (S7). The frame display position calculating portion 23 then proceeds to step S6 to continue the process.

As illustrated in FIG. 5C, for example, when the user is holding the information processing device 1 such that the direction G of the acceleration of gravity coincides with the positive direction of the X-axis (when aₓ>0), supposing that the size of the display section 14 is the width U and the height V (that the lower right coordinates of the display section 14 in FIG. 5C are (u, 0)), the frame display position calculating portion 23 sets a rectangular region whose upper left coordinates represent the touch position (x₀, y₀) and whose lower right coordinates are (u, 0) as an avoidance region.

As illustrated in FIG. 5D, for example, when the user is holding the information processing device 1 such that the direction G of the acceleration of gravity is opposite from the positive direction of the X-axis (when aₓ<0), supposing that the lower right coordinates of the display section 14 in FIG. 5D are (0, v), the frame display position calculating portion 23 sets a rectangular region whose upper left coordinates represent the touch position (x₀, y₀) and whose lower right coordinates are (0, v) as an avoidance region.

Incidentally, when it is determined in step S1 that the touch sensor of the operating section 13 is not touched by a finger of a user (when a result of the determination in S1 is No), the frame display position calculating portion 23 determines the display position of the frame by a method similar to a commonly performed conventional method (S8), outputs information on the determined position, and then ends the process. In a certain example of the present embodiment, in step S8, the size of the display section 14 being the width U and the height V, for example, the display position of the frame having a size width W and a height H is determined in a rectangular region represented by upper left coordinates (x₁, y₁)=(U/2−W/2, V/2−H/2) and lower right coordinates (x₂, y₂)=(U/2+W/2, V/2+H/2). Incidentally, while the frame is displayed in a central part of the screen in this example, there can be various other examples.

In addition, in a certain example of the present embodiment, a process of discontinuing the frame display process in step S8 may be performed. In this case, the message is not displayed when the user takes off the finger.

The frame display control portion 24 draws the frame at the display position determined by the frame display position calculating portion 23, and draws a text as a message within the frame. In addition, the frame display control portion 24 repeatedly checks whether a finger of a user is touching the touch sensor of the operating section 13. When the finger of the user is taken off the touch sensor of the operating section 13, the display of the frame and the message is ended.

Thus, in one aspect of the present embodiment, when a user performs touch operation, the frame display position calculating portion 23 estimates a region on the display section 14 which region is covered by a part of the body of the user as an avoidance region, and determines a position for displaying information in such a manner as to avoid the avoidance region. Then, the frame display control portion 24 draws a frame at the position determined so as to avoid the estimated avoidance region, and displays the information within the frame.

An example of a method of determining a position for displaying a frame in step S6 in the frame display position calculating portion 23 will be described in the following. The following description will be made so as to be divided for the respective cases of FIGS. 5A to 5D. In a manner of holding in FIG. 5A, the coordinates of the upper left corner of the display section 14 are (0, 0), and the coordinates of the lower right corner of the display section 14 are (u, v). In a manner of holding in FIG. 5B, the coordinates of the upper left corner of the display section 14 are (u, v), and the coordinates of the lower right corner of the display section 14 are (0, 0). In a manner of holding in FIG. 5C, the coordinates of the upper left corner of the display section 14 are (0, v), and the coordinates of the lower right corner of the display section 14 are (u, 0). In a manner of holding in FIG. 5D, the coordinates of the upper left corner of the display section 14 are (u, 0), and the coordinates of the lower right corner of the display section 14 are (0, v). Thus, when the avoidance region is to be set on the lower right side of the touch position, the upper left coordinates and the lower right coordinates of the avoidance region in each manner of holding are:

Manner of Holding in FIG. 5A: Upper Left Corner: (x₀, y₀), Lower Right Corner: (u, v)

Manner of Holding in FIG. 5B: Upper Left Corner: (x₀, y₀), Lower Right Corner: (0, 0)

Manner of Holding in FIG. 5C: Upper Left Corner: (x₀, y₀), Lower Right Corner: (u, 0)

Manner of Holding in FIG. 5D: Upper Left Corner: (x₀, y₀), Lower Right Corner: (0, v)

The frame display position calculating portion 23 refers to the size of a determined frame (a width W and a height H), and checks whether the frame of the width W can be displayed on the left side of the avoidance region. This can be determined on the basis of whether a difference ξ between the value on the side of the axis of abscissas (the X-axis in FIG. 5A and FIG. 5B and the Y-axis in FIG. 5C and FIG. 5D) of the coordinates of the upper left corner of the display section 14 and the value on the side of the axis of abscissas (the X-axis in FIG. 5A and FIG. 5B and the Y-axis in FIG. 5C and FIG. 5D) of the touch position in each manner of holding exceeds the width W of the frame or not.

That is, whether W≦ξ is determined with:

Manner of Holding in FIG. 5A: ξ=x₀

Manner of Holding in FIG. 5B: ξ=(u−x₀)

Manner of Holding in FIG. 5C: ξ=(v−y₀)

Manner of Holding in FIG. 5D: ξ=y₀

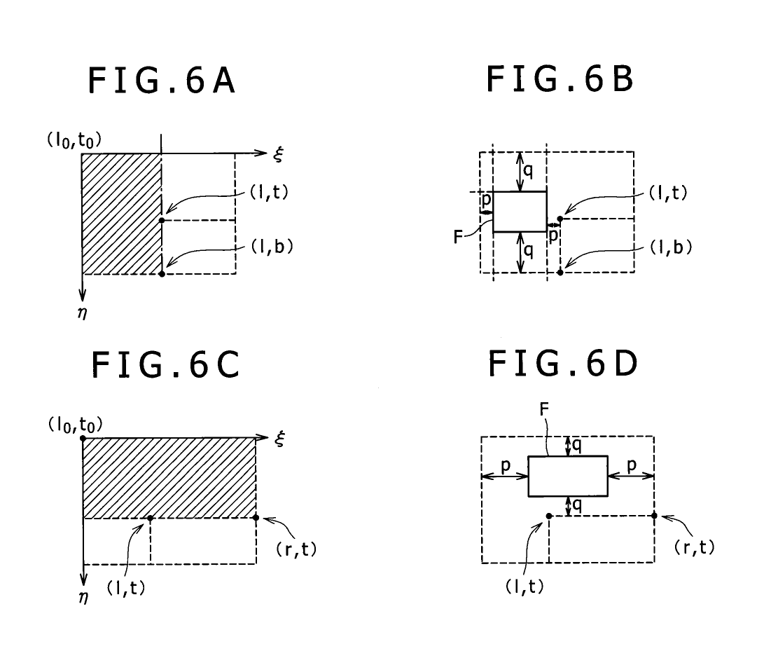

When W≦ξ, and thus the frame of the width W can be displayed on the left side of the avoidance region, the frame display position calculating portion 23 determines the display position of the frame within a range having the touch position as upper left coordinates thereof and having the coordinates of the lower right corner of the display section 14 in the state of being held as lower right coordinates thereof (range hatched in FIG. 6A).

Specifically, when the frame of the width W can be displayed on the left side of the avoidance region, the frame display position calculating portion 23 sets the coordinates of the upper left corner of the display position of the frame at (ξ/2−W/2, η/2−H/2), and sets the coordinates of the lower right corner of the display position of the frame at (ξ/2+W/2, η/2+H/2), where n is the absolute value of a difference between the value on the side of the axis of ordinates (the Y-axis in FIGS. 5A and 5B and the X-axis in FIG. 5C and FIG. 5D) of the coordinates of the upper left corner of the display section 14 and the value on the side of the axis of ordinates of the coordinates of the lower right corner of the display section 14. That is, in manner of holding in FIG. 5A and FIG. 5B, η=v, and in manner of holding in FIG. 5C and FIG. 5D, η=u.

According to this, as illustrated in FIG. 6B, the frame F is displayed in the central part of the range hatched in FIG. 6A (such that p and q in FIG. 6B are each the same value).

When the frame of the width W cannot be displayed on the left side of the avoidance region, that is, when W>ξ, the frame display position calculating portion 23 determines the display position of the frame within a range above the touch position (range hatched in FIG. 6C).

Specifically, when the frame of the width W cannot be displayed on the left side of the avoidance region, the frame display position calculating portion 23 determines the display position of the frame within the following ranges:

Manner of Holding in FIG. 5A: Upper Left Corner: (0, 0), Lower Right Corner: (u, y₀)

Manner of Holding in FIG. 5B: Upper Left Corner: (u, v), Lower Right Corner: (0, y₀)

Manner of Holding in FIG. 5C: Upper Left Corner: (0, v), Lower Right Corner: (x_{0, 0})

Manner of Holding in FIG. 5D: Upper Left Corner: (u, 0), Lower Right Corner: (x₀, v)

Specifically, in this case, the frame display position calculating portion 23 sets the display position of the frame in a central part other than the avoidance region, that is, as follows:

In Manner of Holding in FIG. 5A: Upper Left Corner: (u/2−W/2, y₀/2−H/2), Lower Right Corner: (u/2+W/2, y₀/2+H/2)

In Manner of Holding in FIG. 5B: Upper Left Corner: (u/2+W/2, (v+y₀)/2+H/2), Lower Right Corner: (u/2−W/2, (v−y₀)/2−H/2)

In Manner of Holding in FIG. 5C: Upper Left Corner: (x₀/2−H/2, v/2+W/2), Lower Right Corner: (x₀/2+H/2, v/2−W/2)

In Manner of Holding in FIG. 5D: Upper Left Corner: ((u−x₀)/2+H/2, v/2−W/2), Lower Right Corner: ((u−x₀)/2+H/2, v/2+W/2)

Incidentally, while the frame F in this case is a rectangle, the frame F may be a rounded rectangle having rounded corners, an ellipse, or the like rather than the simple rectangle. In this case, the coordinates of the upper left corner and the lower right corner of a rectangle circumscribed about the rounded rectangle or the like are set as described above. In addition, a figure such as a balloon or the like may be formed by drawing a triangle extended from the frame so as to have a vertex at the touch position (x₀, y₀) together with the frame.

The information processing device 1 according to the present embodiment has the above configuration, and operates as follows. Suppose for example that when an operation of long pressing an icon or the like displayed on the display section 14 is performed, information on the icon or the like is displayed. In this case, when the user desires to refer to the information on the icon or the like, the user performs an operation of long pressing (continuing to touch) the icon whose information the user desires to see. Suppose that the touch position is (x₀, y₀).

In this case, a plurality of virtual regions are defined on the display section 14 in advance. Then, a database associating information identifying each region with a message to be displayed for an icon or the like displayed within the region is retained in the storage section 12. The control section 11 detects that the user is performing long pressing, refers to information on the touch position being long pressed, and determines whether the touch position indicated by the information being referred to is included in one of the regions identified by the information retained in the database.

When the control section 11 determines in this case that the touch position is included in one of the regions identified by the information retained in the database, the control section 11 instructs the API to read out the message associated with the information identifying the region and display the message.

The control section 11 starts processing as the API, receives the text of the message as an object for display, and calculates the size (width w×height h) of a circumscribed rectangle enclosing the received text when the text is arranged in a row direction in units of rows of a predetermined number of characters in a predetermined font. The control section 11 then calculates the frame size as Width W=w+2×Δw and Height H=h+2×Δh by adding each of predetermined offset values (Δw in a direction of width and Δh in a direction of height) to the size of the circumscribed rectangle.

The control section 11 also checks whether a finger of the user is touching the touch sensor of the operating section 13. Because it is assumed in this case that the user continues to touch the touch sensor of the operating section 13, the control section 11 detects the position (x₀, y₀) in the X-Y coordinate system of a pixel corresponding to the position touched by the finger of the user. Meanwhile, the control section 11 obtains the output (a_{z}, a_{y}, a_{z}) of the acceleration sensor 16, and compares |aₓ| and |a_{y}| from the output with each other to determine whether the user is holding the information processing device 1 longitudinally or laterally.

Supposing in this case that as illustrated in FIG. 5A, the user is holding the information processing device 1 such that the direction G of the acceleration of gravity coincides with the positive direction of the Y-axis, |a_{y}|>|aₓ| and a_{y}>0. The control section 11 sets a rectangular region on the lower right side of the point (x₀, y₀) on the display section 14 in this orientation as an avoidance region. That is, the upper left corner of the avoidance region is (x₀, y₀), and the lower right corner of the avoidance region is (u, v).

The control section 11 refers to the determined frame size (the width W and the height H), and checks whether the frame of the width W can be displayed on the left side of the avoidance region (the expression of “left side” will be used in the following because the opposite side of the coordinates at which the touch operation is performed from the side where the avoidance region is provided is the left side, which becomes the right side when the avoidance region is provided on the lower left side of the coordinates at which the touch operation is performed). When the user is holding the information processing device 1 such that the direction G of the acceleration of gravity coincides with the positive direction of the Y-axis as illustrated in FIG. 5A, the control section 11 checks whether W≦x₀. When W>x₀ in this case, the control section 11 determines that the frame cannot be displayed on the left side of the avoidance region, and determines that the frame is to be displayed above the avoidance region. That is, the control section 11 sets a rectangular region having an upper left corner at (u/2−W/2, y₀/2−H/2) and a lower right corner at (u/2+W/2, y₀/2+H/2) as the display position of the frame. Then, the control section 11 draws the frame in the thus determined display position, and draws the text as message within the frame.

On the other hand, when the user is holding the information processing device 1 such that the direction G of the acceleration of gravity is opposite from the positive direction of the X-axis as illustrated in FIG. 5D, |aₓ|>|a_{y}| and aₓ<0. The control section 11 sets a rectangular region on the lower right side of the point (x₀, y₀) on the display section 14 in this orientation as an avoidance region. That is, the upper left corner of the avoidance region is (x₀, y₀), and the lower right corner of the avoidance region is (0, v).

The control section 11 refers to the determined frame size (the width W and the height H), and checks whether the frame of the width W can be displayed on the left side of the avoidance region. The control section 11 in this case checks whether W≦y₀. When W≦y₀ in this case, the control section 11 determines that the frame can be displayed on the left side of the avoidance region, and determines that the frame is to be displayed on the left side of the avoidance region. That is, the control section 11 sets the coordinates of an upper left corner of the display position of the frame at (u/2+H/2, y₀/2−W/2) and sets the coordinates of a lower right corner of the display position of the frame at (u/2−H/2, y₀/2+W/2). Then, the control section 11 draws the frame in the thus determined display position, and draws the text as message within the frame.

Incidentally, control is performed in this case so that the frame is displayed on the left side of the avoidance region when the frame can be displayed on the left side of the avoidance region. However, the display control is not limited to this. The frame may be displayed above the avoidance region regardless of whether the frame can be displayed on the left side of the avoidance region.

Further, it is assumed in this case that there is always a region where the frame can be displayed above the avoidance region. However, when the user is touching a relatively higher position of the display section 14, for example, it may not be possible to display the frame in a position above the avoidance region or the like in such a manner as to avoid the avoidance region.

In such a case, the control section 11 may repeat a process of decrementing the font size of the text of the message to be displayed by a predetermined size and determining the size of the frame. This reduces the size of the text of the message until the frame can be displayed.

In addition, when the frame cannot be displayed in such a manner as to avoid the avoidance region, the control section 11 may perform the following process. The control section 11 may determine the display position of the frame by a method similar to that of step S8, and draw the frame at the determined position and draw the text as message within the frame. In this case, the frame display control portion 24 of the control section 11 further continues the display of the frame and the message for a predetermined time after the user takes the finger off the operating section 13, that is, after an end of the touch operation by the user, and ends the display of the frame and the message after the passage of the predetermined time.

In this case, the control section 11 may receive an enlarging or reducing instruction from the user while continuing the display of the frame and the message for the predetermined time after an end of the touch operation by the user, and as the process of the frame display control portion 24, display the frame and the message as information being displayed in an enlarged or reduced state according to the received instruction. The enlarging or reducing instruction may be an operation of a so-called pinch in or pinch out such that the operating section 13 is touched with two fingers and an interval between the two fingers is thereafter increased to give the enlarging instruction or the interval between the two fingers is decreased to give the reducing instruction. In addition, the enlarging or reducing instruction may be an operation of moving a finger while touching a predetermined range (for example a range of a predetermined number of pixels from each of four corners) within the frame (which operation is similar to a so-called flick operation), and when the instruction is received, the coordinates of a vertex located in the vicinity of a position touched by the finger may be changed according to the movement of the finger. As for an enlarging or reducing process when this instruction is received, it suffices to enlarge or reduce the image displayed within the range of the width W and the height H as it is (including not only the frame but also the image of the text of the message), and display the enlarged or reduced image. Thus, the control section 11 functions as means for displaying the information during the predetermined time after an end of the touch operation by the user, and receiving the enlarging or reducing instruction from the user during the display of the information.

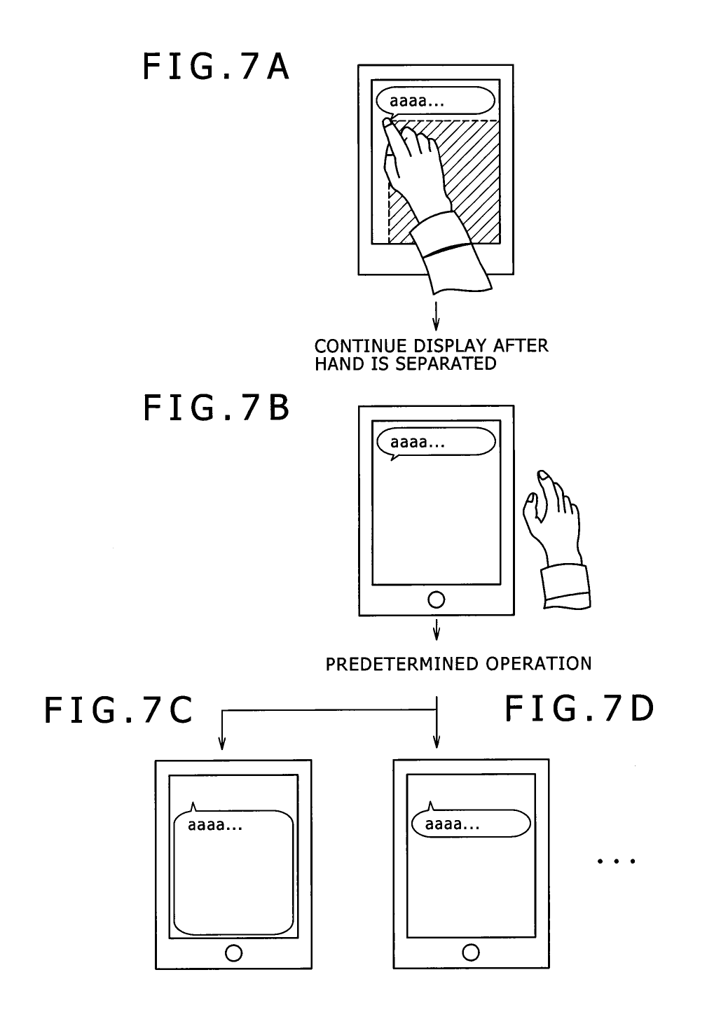

In addition, when the avoidance region is relatively large, and there is thus no region where the whole of the frame can be displayed, the control section 11 may perform the following process. When the whole of the frame cannot be displayed, the control section 11 may display a part of the frame, or display a message indicating that there is a frame that cannot be displayed. An example of such display is shown in FIG. 7A.

When display is made in a case where there is no region in which the whole of the frame can be displayed as illustrated in FIG. 7A, the control section 11 continues the display of the frame and the message at least for a predetermined time even after an end of the touch operation by the user (FIG. 7B). When the user performs a predetermined operation such as tapping another position (operation of touching a certain position of the operating section 13 and taking the finger off the certain position of the operating section 13) or tapping the frame being displayed twice consecutively (double tap) while the display is continued, the control section 11 may perform a process as the frame display position calculating portion 23 again. In this process, the finger of the user is already separated, so that the frame is displayed irrespective of the avoidance region determined earlier (FIG. 7C). As an example, the frame in this case is displayed in the central part of the display section 14.

In another example of the present embodiment, when the user performs a predetermined operation such as a double tap or the like while the display is continued as in FIG. 7B, the control section 11 may turn down the coordinates of the frame symmetrically with respect to a horizontally oriented virtual axis obtained by extending a lower side of a rectangle circumscribed about the frame (which axis is parallel to the X-axis in the manner of holding in FIG. 5A or 5B or the Y-axis in the manner of holding in FIG. 5C or 5D), and display the frame again (FIG. 7D). In another example, the control section 11 may move the frame to coordinates obtained by rotating the frame by 180 degrees about a double-tapped position, and then display the frame (this produces substantially the same result as in FIG. 7D).

Further, in another example of the present embodiment, when the user performs a predetermined operation and thereafter specifies the display position of the frame while the display is continued as in FIG. 7B, the control section 11 may receive information on the specified display position, and change the display position of the frame on the basis of the information. As this operation, it suffices for example to long press the frame or the message being displayed, and thereafter perform a tap operation for specifying the display position.

The control section 11 changes the display position of the frame as follows, for example, on the basis of the received information specifying the display position (which information is the coordinates at which the tap operation is performed or the like). When the received information on the display position is (x, y), and the rectangle circumscribed about the frame as an object for display has a width W and a height H, the control section 11 calculates the display position of the frame as follows.

The control section 11 extracts the coordinate value (y) on the Y-axis in the case where the user is holding the information processing device 1 in the manner of holding in FIG. 5A or FIG. 5B or the coordinate value (x) on the X-axis in the case where the user is holding the information processing device 1 in the manner of holding in FIG. 5C or FIG. 5D from the coordinates of the specified display position, and sets the coordinate value as ξ. In addition, the control section 11 extracts the coordinate value on the Y-axis in the case where the user is holding the information processing device 1 in the manner of holding in FIG. 5A or FIG. 5B or the coordinate value on the X-axis in the case where the user is holding the information processing device 1 in the manner of holding in FIG. 5C or FIG. 5D from the coordinates of the lower right corner of the display section 14, and sets the coordinate value as η. That is, when the size of the display section 14 is u×v, η=v in the manner of holding in FIG. 5A, η=0 in the manner of holding in FIG. 5B, η=u in the manner of holding in FIG. 5C, and η=0 in the manner of holding in FIG. 5D.

Next, the control section 11 calculates |ξ−η|, and checks whether |ξ−| is not larger than H/2 (whether the frame extends off the display section 14 when the center in the direction of height of the frame is set at ξ). When |ξ−η|≦H/2, the control section 11 sets ξ=η−H/2. When |ξ−η|>H/2, the control section 11 sets ξ as it is.

When the manner of holding of the information processing device 1 by the user is the manner of holding in FIG. 5A, the control section 11 sets the upper left corner of the display position of the frame at (u/2−W/2, y−H/2) and sets the lower right corner of the display position of the frame at (u/2+W/2, y+H/2). When the manner of holding of the information processing device 1 by the user is the manner of holding in FIG. 5B, the control section 11 sets the upper left corner of the display position of the frame at (u/2+W/2, y+H/2) and sets the lower right corner of the display position of the frame at (u/2−W/2, y−H/2).

When the manner of holding of the information processing device 1 by the user is the manner of holding in FIG. 5C, the control section 11 sets the upper left corner of the display position of the frame at (x−H/2, v/2+W/2) and sets the lower right corner of the display position of the frame at (x+H/2, v/2−W/2). When the manner of holding of the information processing device 1 by the user is the manner of holding in FIG. 5D, the control section 11 sets the upper left corner of the display position of the frame at (x+H/2, v/2−W/2) and sets the lower right corner of the display position of the frame at (x−H/2, v/2+W/2).

The control section 11 draws the frame in the thus calculated display position of the frame, and draws the text specified as an object for display within the frame.

Further, in the above description, the avoidance region is on the lower right side of the coordinates at which the touch operation is performed. However, the present embodiment is not limited to this. For example, the avoidance region is preferably on the lower left side of the coordinates at which the touch operation is performed for a user often performing operation with a finger of a left hand while holding the information processing device 1 with a right hand. Also in this case, the avoidance region can be determined so as to correspond to the respective cases of FIGS. 5A to 5D as in the example already described.

In addition, in the description thus far, when the frame cannot be displayed in a range other than the avoidance region, and the frame is thus displayed in a range overlapping the avoidance region, the frame display control portion 24 of the control section 11 continues the display of the frame and the message for a predetermined time after an end of the touch operation by the user, and ends the display of the frame and the message after the passage of the predetermined time. However, the process of continuing the display of the frame and the message for a predetermined time after an end of the touch operation by the user and ending the display of the frame and the message after the passage of the predetermined time may be performed not only when the frame cannot be displayed in such a manner as to avoid the avoidance region but also when the frame can be displayed in such a manner as to avoid the avoidance region.

In either case, when the display of the frame and the message is thus continued for a predetermined time after an end of the touch operation by the user, the control section 11 may receive an enlarging or reducing operation as already described or the like, and enlarge or reduce the frame and the image of the text within the frame according to the operation.

Further, the text displayed within the frame by the control section 11 may include a link such as reference information (for example an URL: Uniform Resource Locator) or the like indicating a source from which information can be obtained via a communication line such as the Internet or the like. In this case, when the display of the frame and the message is thus continued for a predetermined time after an end of the touch operation by the user, the control section 11 may repeatedly determine whether a part of the character string which part corresponds to the link within the frame is tapped while the display is continued. Thus, the control section 11 functions as means for displaying the information during the predetermined time after an end of the touch operation by the user, and when the displayed information includes a link indicating a source from which to obtain other information, receiving an instruction to obtain the other information from the source indicated by the link from the user during the display of the information.

When the part of the text which part corresponds to the link within the frame is tapped, the control section 11 for example starts the application such as a web browser and makes a process of opening the link performed. Thereby, the other information different from the text as the message is obtained from the source indicated by the link, and displayed.

Incidentally, when there are a plurality of links within the frame, and the inside of the frame is tapped, the control section 11 may display a list obtained by extracting only the links and allow the user to select a link.

Further, in view of a fact that the information processing device 1 can be placed and operated on a flat surface of a table or the like, the control section 11 repeatedly obtains attitude information indicating the attitude of the information processing device 1 which attitude is detected by the acceleration sensor 16 in predetermined timing (periodically at certain time intervals, for example). The control section 11 stores at least the attitude information obtained last (information indicating in which of the orientations of FIGS. 5A to 5D the information processing device 1 was held) in the storage section 12. When the control section 11 operates as the frame display position calculating portion 23, the control section 11 may perform for example a process of determining in which of the orientations of FIGS. 5A to 5D the user is viewing the information processing device 1 (supposing that a viewpoint of the user is in the direction of the acceleration of gravity in each case) using the attitude information stored in the storage section 12, and determining the display position of the frame. Thus, the control section 11 functions as means for repeatedly obtaining the attitude information indicating the attitude detected by the acceleration sensor 16 in predetermined timing, and storing at least the attitude information obtained last.

It should be understood by those skilled in the art that various modifications, combinations, sub-combinations and alterations may occur depending on design requirements and other factors insofar as they are within the scope of the appended claims or the equivalents thereof.

What is claimed is:

1. An information processing device comprising:
a display section;
a touch sensor superposed on the display section, the touch sensor being responsive to touch operation by a user;
an estimation unit configured to identify a region on the display section, the region being covered by a part of the user, when the touch sensor detects the touch operation by the user; and
a display controller that displays information on the display section so as to avoid the region identified by the estimation unit.

2. The information processing device according to claim 1, wherein
the display controller displays the information for a predetermined time after an end of the touch operation, and
the information processing device further includes an interface that receives an enlarging or a reducing instruction via the touch sensor during the display of the information, and
in response to the enlarging or reducing instruction being received, the display controller causes the information to be displayed in an enlarged or reduced state according to the instruction.

3. The information processing device according to claim 1, wherein
the display controller causes the display section to display the information for a predetermined time after an end of the touch operation, and
the information processing device further includes an interface that receives an instruction to obtain other information from a source identified by a link, and obtains the other information from the source indicated by the link and displaying the other information when the instruction is given.

4. The information processing device according to claim 1, further comprising:
an acceleration sensor that detects an attitude of the information processing device; and
an interface that repeatedly obtains attitude information indicating the attitude detected by the acceleration sensor in predetermined timing, and storing at least the attitude information last obtained,
wherein the estimating unit estimates the region on the display section, the region being covered by the part of the body of the user, the region being covered by the part of the body of the user, on a basis of the stored attitude information last obtained.

5. A non-transitory recording medium having instructions stored therein that when executed by a computer cause the computer to implement an information processing device that is connected to a display section and a touch sensor superposed on the display section, the touch sensor being responsive to touch operation by a user, the information processing device comprising:
an estimation unit configured to identify a region on the display section, the region being covered by a part of the user, when the touch sensor detects the touch operation by the user; and
a display controller that that displays information on the display section so as to avoid the region identified by the estimation unit.
